(19) United States
(12) Patent Application Publication
(10) Pub. No.: US 2020/0285375 A1
(43) Pub. Date: Sep. 10, 2020

(54) Display Method And Display Apparatus

(71) Applicant: Seiko Epson Corporation, Tokyo (JP)

(72) Inventor: Yusuke YAMADA, Shiojiri (JP)

(21) Appl. No.: 16/807,196

(22) Filed: Mar. 3, 2020

(30) Foreign Application Priority Data
Mar. 4, 2019 (JP) 2019-038288

(51) Int. Cl. G06F 3/0484; G06F 3/0483; G06T 7/40

(52) U.S. Cl. CPC G06F 3/04845; G06T 7/40; G06F 3/0483

(57) ABSTRACT

A display method according to the present disclosure includes rotating a plurality of images arranged along a first imaginary axis of rotation around a second imaginary axis of rotation that intersects the first imaginary axis of rotation, further rotating the plurality of images around the first imaginary axis of rotation, and displaying the plurality of images on a display section. The images are each a texture selected from a texture band and having a resolution according to the size of the image displayed on the display section, and the texture band is a ripmap in which the textures are arranged in a first direction along the first imaginary axis.

The present application is based on, and claims priority from JP Application Serial Number 2019-038288, filed Mar. 4, 2019, the disclosure of which is hereby incorporated by reference herein in its entirety.

### BACKGROUND

### 1. Technical Field

The present disclosure relates to a display method and a display apparatus.

### 2. Related Art

To allow a user to grasp the content of document data formed of a plurality of pages, there is an invented technology for generating a thumbnail image of each of the plurality of pages and displaying the plurality of generated thumbnail images in the form of a list in which the thumbnail images are juxtaposed or overlap with one another, and the technology is disclosed in JP-A-2011-221586.

In the display method described in JP-A-2011-221586, however, the resolution of the thumbnail images does not accord with the size of an image to be displayed, and the displayed image is blurred when the resolution is low or jaggy when the resolution is too high. The displayed image therefore does not have optimum resolution corresponding to the size of the image, resulting in a problem of poor visibility of the displayed image depending on the size thereof.

### SUMMARY

A display method according to an aspect of the present application includes rotating a plurality of images arranged along a first imaginary axis around a second imaginary axis that intersects the first imaginary axis, further rotating the plurality of images around the first imaginary axis, and displaying the plurality of images on a display section. The images are each a texture selected from a texture band and having a resolution according to a size of the image displayed on the display section, and the texture band is a ripmap in which the textures are arranged in a first direction along the first imaginary axis.

In the display method described above, the texture band may have any of resolutions in the first direction reduced to a predetermined resolution multiplied by 1, ½, ¼, ⅛, 1/16, and 1/32 and any of resolutions in a second direction that intersects the first direction reduced to the predetermined resolution multiplied by 1, ½, ¼, ⅛, 1/16, and 1/32.

A display method according to another aspect of the present application includes rotating a plurality of images arranged along a first imaginary axis around a second imaginary axis that intersects the first imaginary axis, further rotating the plurality of images around the first imaginary axis, and displaying the plurality of images on a display section. The images are each a texture selected from a plurality of texture atlases having different resolutions in a first direction along the first imaginary axis and having a resolution according to a size of the image displayed on the display section, and the textures are attached to planes each drawn with degenerated triangles and surrounded by a plurality of vertices and then displayed on the display section.

In the display method described above, the texture atlases may each have any of resolutions in the first direction reduced to a predetermined resolution multiplied by 1, ½, ¼, ⅛, 1/16, and 1/32.

A display apparatus according to another aspect of the present application includes a display section that displays an image bundle formed of a plurality of images, an image generator that rotates the plurality of images arranged along a first imaginary axis around a second imaginary axis that intersects the first imaginary axis and further rotates the plurality of images around the first imaginary axis to generate the plurality of images, and a controller that selects textures having resolutions according to sizes of the images displayed on the display section from a texture band that is a ripmap in which the textures are arranged in a first direction along the first imaginary axis.

A display apparatus according to another aspect of the present application includes a display section that displays an image bundle formed of a plurality of images, an image generator that rotates the plurality of images arranged along a first imaginary axis around a second imaginary axis that intersects the first imaginary axis and further rotates the plurality of images around the first imaginary axis to generate the plurality of images, and a controller that selects textures having resolutions according to sizes of the images displayed on the display section from a plurality of texture atlases having different resolutions in a first direction along the first imaginary axis, attaches the textures to planes each drawn with degenerated triangles and surrounded by a plurality of vertices, and then displays the textures on the display section.

### BRIEF DESCRIPTION OF THE DRAWINGS

FIG. 1 shows the exterior appearance of a viewer according to a first embodiment.

FIG. 2 shows an image bundle displayed on an image display section.

FIG. 3 is a block diagram showing the system configuration of the viewer.

FIG. 4 is a block diagram showing the system configuration of the viewer.

FIG. 5 is a flowchart showing an example of processes carried out by the viewer.

FIG. 6A shows a texture band that is a ripmap only in the lateral direction.

FIG. 6B shows a texture band that is a ripmap only in the lateral direction.

FIG. 6C shows a texture band that is a ripmap only in the lateral direction.

FIG. 7A describes an image generation process.

FIG. 7B describes the image generation process.

FIG. 7C describes the image generation process.

FIG. 7D describes the image generation process.

FIG. 7E describes the image generation process.

FIG. 8 is a flowchart showing an example of processes carried out by the viewer according to a second embodiment.

FIG. 9A show a texture atlas.

FIG. 9B show a texture atlas.

FIG. 9C show a texture atlas.

FIG. 10 describes a method for processing an image by drawing the image with degenerated triangles.

FIG. 11 describes the method for processing an image by drawing the image with degenerated triangles.

FIG. 12 describes the method for processing an image by drawing the image with degenerated triangles.

### DESCRIPTION OF EXEMPLARY EMBODIMENTS

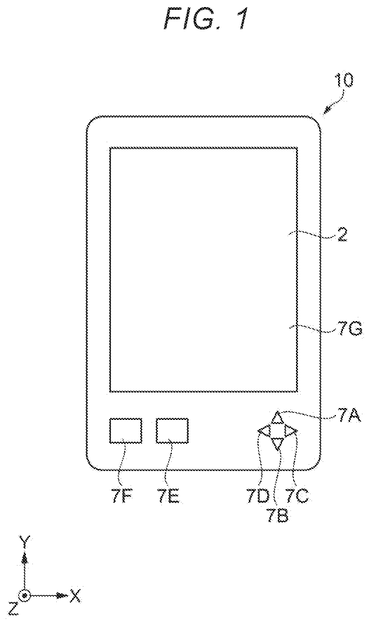

A display method and a display apparatus according to embodiments of the present disclosure will be described below with reference to the drawings. In the embodiments of the present disclosure, the display apparatus will be described with reference to a viewer that allows a user to view and edit an electronic manual and an electronic book, which are each an example of a document containing images, or a document created by the user. In the drawings referred to in the following description, a member or a portion is drawn in longitudinal and lateral scales different from actual scales in some cases for convenience of description and illustration. Further, components other than those necessary for the description are not illustrated in some cases. The following FIGS. 1, 2, 6A, 6B, 6C, 9A, 9B, 9C, 10, 11, and 12 show axes X, Y, and Z as three axes perpendicular to one another for ease of description, and the side facing the front end of the arrow representing any of the axes is a “+” side, and the side facing the base end of the arrow is a “−” side. The direction along the axis X is called a “lateral direction” as a first direction, and the direction along the axis Y is called a “longitudinal direction” as a second direction. A side of the lateral direction that is the side corresponding to the direction −X is called left or a left side, and a side of the lateral direction that is the side corresponding to the direction +X is called right or a right side. A side of the longitudinal direction that is the side corresponding to the direction −Y is called below or a lower side, and a side of the longitudinal direction that is the side corresponding to the direction +Y is called above or an upper side.

### First Embodiment

### Overview of Viewer

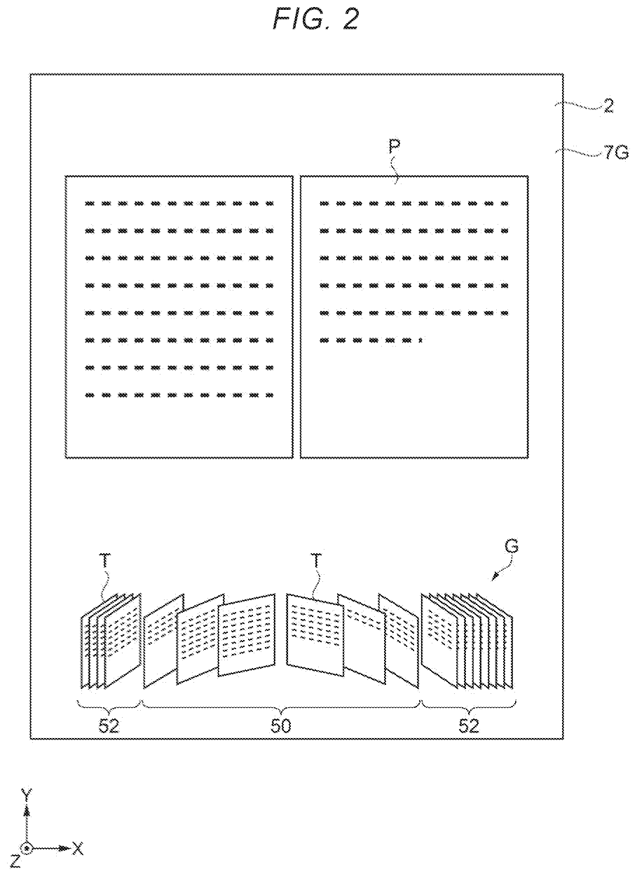

First of all, an overview of a viewer 10 according to a first embodiment will be described with reference to FIGS. 1 and 2.

FIG. 1 shows the exterior appearance of the viewer according to the first embodiment and is a front view of the viewer 10 viewed from the side facing an image display section 2 as a display section. FIG. 2 shows an image bundle G formed of a plurality of images T displayed on the image display section 2.

The viewer 10 according to the present embodiment is a display apparatus that displays an image. In this example, the viewer 10 is an apparatus for viewing an electronic book as an example of a document or what is called an electronic book reader. The electronic book is document data containing images on a plurality of pages. The viewer 10 displays the electronic book on a certain unit basis on the image display section 2. The certain unit is, for example, a single page. Among a plurality of pages contained in the electronic book, a page to be displayed is called a selected page. The selected page is changed in accordance with a user's operation performed on buttons 7A to 7F or a touch panel 7G shown in FIG. 1. That is, the user can operate the buttons 7A to 7F or the touch panel 7G to turn a page of the electronic book and enlarge and display the selected page. The viewer 10 has the function of executing an application program in addition to the function of viewing an electronic book.

The image display section 2 according to the present embodiment displays an image bundle G, in which images T of the pages of an electronic manual, an electronic book, or a document created by the user are arranged in the lateral direction, in a lower portion of the image display section 2. Upon an enlargement instruction of enlargement and display of an image T selected from those in the image bundle G, the viewer 10 displays an enlarged image P above the image bundle G, as shown in FIG. 2.

The image bundle G is formed of a static section 52, where images T are arranged at equal intervals, and a central dynamic section 50, where the interval between adjacent images T is greater than the interval between adjacent images T in the static section 52. The image bundle G is disposed in a laterally central portion of the image display section 2 along the lower edge of the image display section 2.

The images T are images so sized as to occupy part of the image display section 2 and are each a texture having a resolution according to the size of an image T selected from a texture band. The texture band is a ripmap in which original images are arranged only in the lateral direction and is created in advance. The ripmap is a set of textures each having longitudinal and lateral resolutions separately reduced from those of the original images by a factor of a power of two. The texture band is a set of textures only in a lateral row in the ripmap with the textures having a longitudinal resolution equal to that of the original images and a lateral resolution reduced from that of the original images by a factor of a power of two.

The original images are images of the pages of an electronic manual, an electronic book, or document data created by the user. The original images may instead be icons of application programs or action screens of application programs. An application program and the action thereof may be allocated to each of the plurality of images T.

The viewer 10 has the buttons 7A to 7F and the touch panel 7G as an input section 7 provided on a surface of the viewer 10 that is the surface where the image display section 2 is disposed. The input section 7 externally takes in an input. The input section 7 accepts the user's operation and processes the accepted operation as an input signal. That is, the user operates the input section 7 to input predetermined operation to the viewer 10.

### System Configuration of Viewer

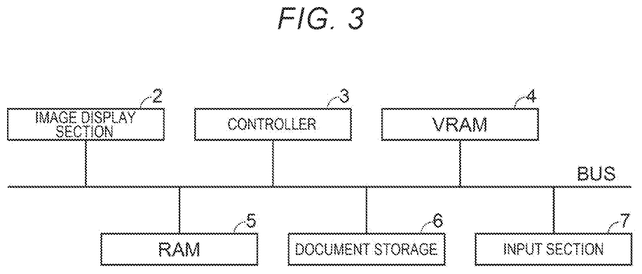

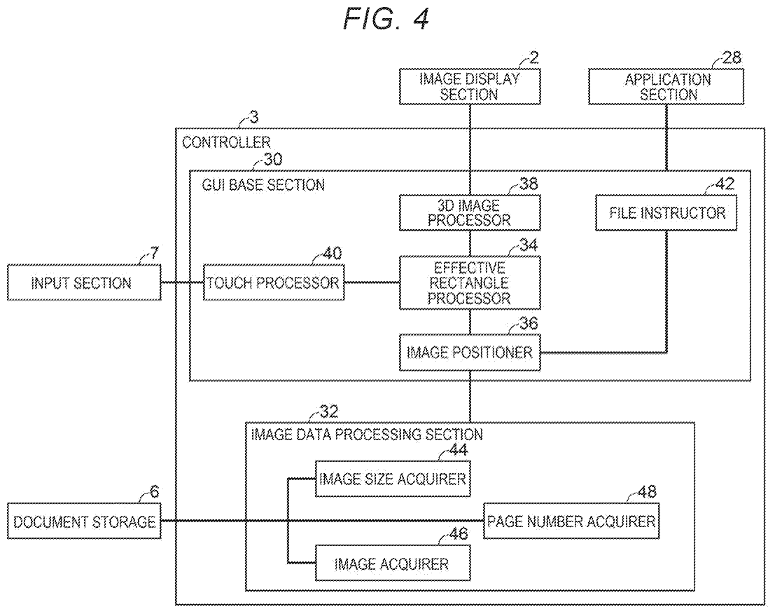

The system configuration of the viewer 10 will next be described with reference to FIGS. 3 and 4.

FIGS. 3 and 4 are each a block diagram showing the system configuration of the viewer 10.

The viewer 10 includes the image display section 2, a controller 3, a video random access memory (VRAM) 4, a random access memory (RAM) 5, a document storage 6, and the input section 7, which are connected to a bus BUS. Transmission and reception of a signal or information between the portions connected to the bus BUS is performed via the bus BUS.

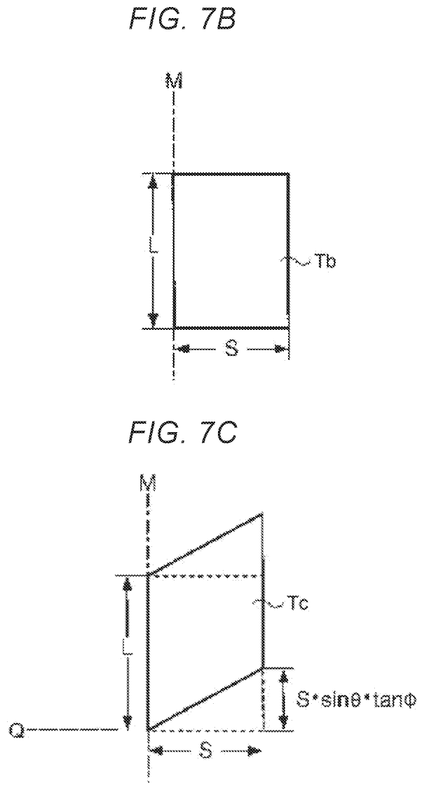

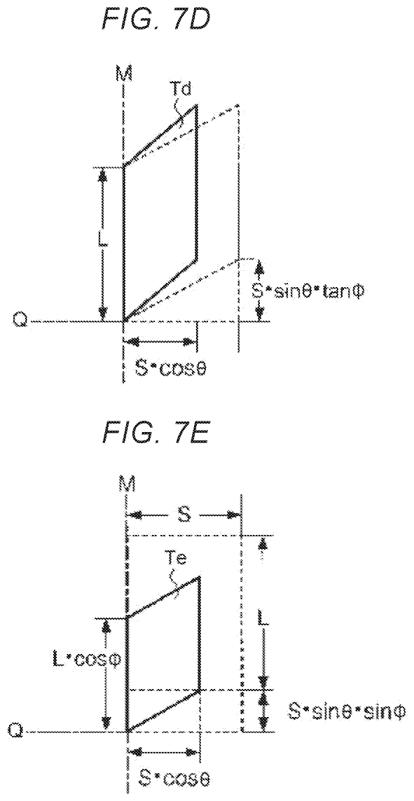

The image display section 2 displays the image bundle G, in which the plurality of images T corresponding to the original images are arranged in the lateral direction. Upon the enlargement instruction of enlargement and display of an image T selected from those in the image bundle G, the image display section 2 enlarges the image T indicated by the enlargement instruction and displays the enlarged image T above the image bundle G. The image display section 2 displays a bird's-eye view that is an image of the image bundle G in which textures Te, which are images T arranged in an imaginary space having a first imaginary axis of rotation Q as a first imaginary axis and a second imaginary axis of rotation M as a second imaginary axis, as shown in FIG. 7E, which will be described later, are laterally arranged and which is viewed from an arbitrary viewpoint in the imaginary space.

The image display section 2 includes a display drive circuit that is not shown but outputs a signal that causes a liquid crystal panel or any other component to display an image. The image display section 2 displays image data stored in the VRAM 4 in the form of an image.

The controller 3 is an apparatus that controls each portion of the viewer 10, for example, a microcomputer including a central processing unit (CPU), a graphics processing unit (GPU), a read only memory (ROM), and other components. The CPU and the GPU execute a program stored in the ROM or the RAM 5 by using the RAM 5 as a work area. The GPU creates the texture band from the original images and stores the created texture band in the VRAM 4. The ROM stores, for example, an operating system (OS) program for controlling a basic action of the viewer 10.

The controller 3 controls each portion of the viewer 10 based on the program stored in the ROM. For example, the controller 3 creates the texture band that generates image data from the original images and stores the texture band in the VRAM 4, identifies, from the input signal transmitted from the input section 7, the content of operation performed on any of the buttons 7A to 7F and the touch panel 7G operated by the user, and operates the viewer 10 based on the operated one of the buttons 7A to 7F and the touch panel 7G and the identified content. Further, the controller 3 selects a texture having a resolution according to the size of an image to be displayed on the image display section 2 from the texture band and controls image processing. Examples of the image processing may include deformation of the textures in such a way that the images T form a bird′-eye image.

The VRAM 4 is a memory that stores the texture band containing the original images for producing the images T to be displayed on the image display section 2 and stores image data on a texture having been selected from the texture band and having undergone the image processing. The image data stored in the VRAM 4 is displayed on the image display section 2.

The RAM 5 is a memory that stores the relationship between the content of the image processing performed by the controller 3 and the image data.

The document storage 6 is a rewritable memory and stores document data, such as an electronic manual, an electronic book, or a document created by the user. The document storage 6 can store a plurality of different sets of document data and rewrite the document data as appropriate. The document storage 6 is a nonvolatile memory that stores a variety of data and application programs in addition to the document data. The document storage 6 may, for example, be a semiconductor memory built in the viewer 10 or a detachable external memory, such as an SD memory card.

The input section 7 includes the buttons 7A to 7F shown in FIG. 1. When any of the buttons 7A to 7F is operated, the input section 7 transmits an input signal corresponding to the operated button to the controller 3. The input section 7 includes the touch panel 7G.

The controller 3 includes a GUI base section 30 as an image generator and an image data processing section 32, as shown in FIG. 4.

The GUI base section 30 rotates the textures that form the plurality of images T and are arranged along the first imaginary axis of rotation Q around the second imaginary axis of rotation M, which intersects the first imaginary axis of rotation Q, and further rotates the textures around the first imaginary axis of rotation Q to generate the images T. The GUI base section 30 generates a bird's-eye image that is an image of the image bundle G disposed in the imaginary space and viewed from an arbitrary viewpoint in the imaginary space.

The GUI base section 30 includes an effective rectangle processor 34, an image positioner 36, a 3D image processor 38, a touch processor 40, and a file instructor 42.

The effective rectangle processor 34 sets an image display area.

The image positioner 36 determines angles of rotation θ by which the textures are rotated around the second imaginary axis of rotation M. The GUI base section 30 generates the images T based on the determined angles of rotation θ.

The image positioner 36 divides the image bundle G formed of the plurality of images T into the static section 52, where images T are arranged at equal intervals, and the dynamic section 50, where the interval between adjacent images T is greater than the interval between adjacent images T in the static section 52, with adjacent images T overlapping each other and determines the positions where the plurality of images T are arranged in the static section 52 and the dynamic section 50.

The 3D image processor 38 is, for example, a FrameBuffer, which is a GPU.

The 3D image processor 38 performs calculation necessary for image drawing, such as 3D graphics, and creates, based on the original images of the pages, a texture band containing textures having a resolution according to the size of the images T to be displayed.

The touch processor 40 detects the user's operation of touching the touch panel 7G. The touch processor 40 acquires a touch signal from the touch panel 7G.

The file instructor 42 instructs the image processing section 32 to read the original images of the pages of the document data based on the data supplied from the touch processor 40. The file instructor 42 is, for example, a function of Android (registered trademark), which is an operation system for mobile instruments.

The image data processing section 32 is, for example, a PDF library.

The image data processing section 32 includes an image size acquirer 44, an image acquirer 46, and a page number acquirer 48.

The image size acquirer 44 acquires the lateral and longitudinal lengths of the original images of the pages of the document data from the document storage 6.

The image acquirer 46 acquires the original images of the pages of the document data from the document storage 6.

The page number acquirer 48 acquires the number of pages of the document data from the document storage 6.

An application section 28 is, for example, application software, such as software for printing a photograph and a document, software for printing new-year's cards, and software for projecting a photograph, a document, and other objects via a projector.

### Action of Viewer

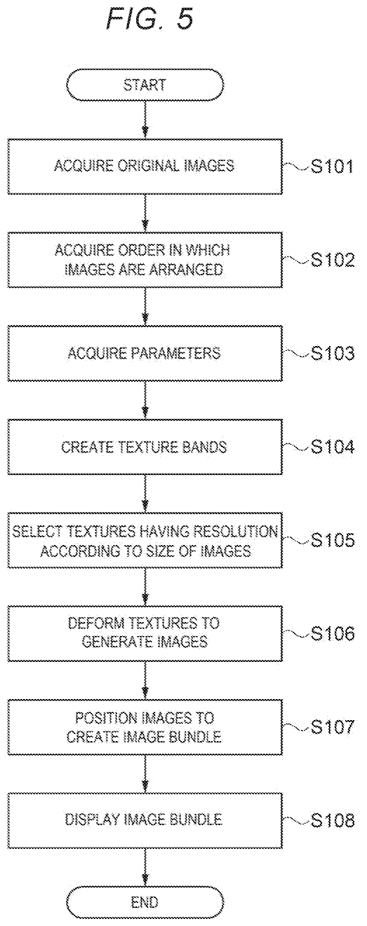

The action of the viewer will next be described with reference to FIGS. 5 to 7E.

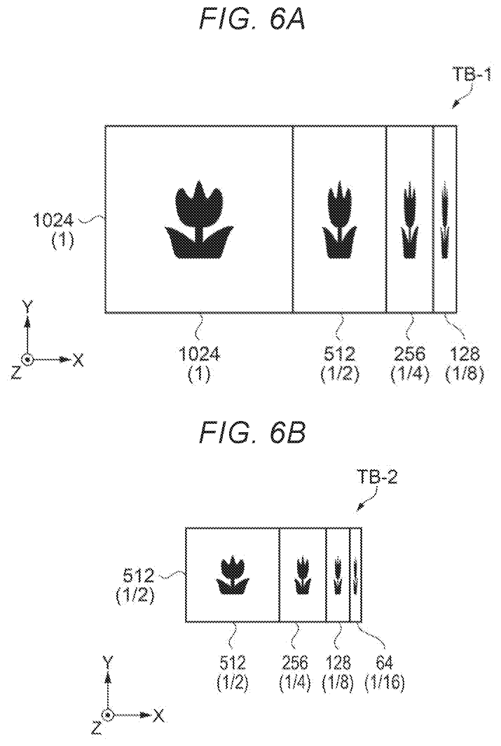

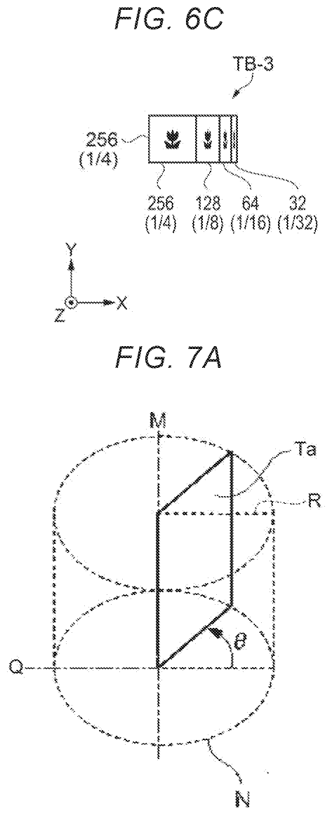

FIG. 5 is a flowchart showing an example of processes carried out by the viewer 10. FIGS. 6A to 6C show a texture band that is a ripmap only in the lateral direction. FIGS. 7A to 7E describe an image generation process. The action of the controller 3 will be described below along the flowchart of FIG. 5 with reference to FIG. 2.

The flowchart shown in FIG. 5 starts in response to a trigger, for example, when a predetermined event occurs, for example, the viewer 10 is powered, or when the viewer 10 is instructed, for example, to display a menu screen.

In step S101, the controller 3 first acquires the image bundle G to be process target, in this example, the original images of the plurality of images T contained in the image bundle G from the document storage 6.

In step S102, the controller 3 then acquires data representing the order in which the plurality of images T are arranged from the document storage 6. The data contains identifiers of the images T and numbers representing the order.

In step S103, the controller 3 then acquires parameters used to display the image bundle G. The parameters are stored in document storage 6 along with the identifiers of the image bundle G. The acquired parameters include the number of images and the width of the images. The number of images is a parameter representing the number of images T contained in the image bundle G. The width of the images is a parameter representing the lateral length of the image bundle G.

In step S104, the controller 3 then causes the GUI base section 30 to create a texture band corresponding to the pages from the original images of the pages. In detail, the controller 3 causes the GUI base section 30 to create a texture band having a lateral resolution reduced from that of the original images of the pages acquired in step S101 by a factor of a power of two and stores all texture bands corresponding to the pages in the VRAM 4.

The texture bands created by the GUI base section 30 will now be described.

The controller 3 causes the GUI base section 30 to create, based on the original images of the pages, a texture band TB-1 formed of a texture having a longitudinal resolution of 1024 bytes and a lateral resolution of 1024 bytes, a texture having the longitudinal resolution of 1024 bytes and a lateral resolution of 512 bytes, a texture having the longitudinal resolution of 1024 bytes and a lateral resolution of 256 bytes, and a texture having the longitudinal resolution of 1024 bytes and a lateral resolution of 128 bytes, as shown in FIG. 6A, and stores the texture band TB-1 in the VRAM 4. The texture band TB-1 is formed of textures having lateral resolutions reduced by a power of two, that is, the predetermined resolution of 1024 bytes multiplied by 1, ½, ¼, and ⅛. The texture band TB-1 can be created by executing a ripmap creation program stored in the RAM 5.

The controller 3 further creates a texture band TB-2 formed of a texture having a resolution of 512×512 bytes, a texture having a resolution of 512×256 bytes, a texture having a resolution of 512×128 bytes, and a texture having a resolution of 512×64 bytes, the longitudinal resolution of each of which is half the longitudinal resolution of the texture band TB-1, or a texture band TB-3 formed of a texture having a resolution of 256×256 bytes, a texture having a resolution of 256×128 bytes, a texture having a resolution of 256×64 bytes, and a texture having a resolution of 256×32 bytes, the longitudinal resolution of each of which is a quarter of the longitudinal resolution of the texture band TB-1, in accordance with the size of the images T to be displayed, as shown in FIGS. 6B and 6C, and stores the texture bands TB-2 and TB-3 in the VRAM 4. Depending on the size of the images T to be displayed, the controller 3 may create a texture band having a lateral resolution reduced to the predetermined resolution of 1024 bytes multiplied by 1/16 or 1/32. The controller 3 may create a texture band having a longitudinal resolution reduced to the predetermined resolution of 1024 bytes multiplied by ⅛, 1/16 or 1/32 depending on the size of the images T to be displayed.

In step S105, the controller 3 then reads a texture band containing textures each having the resolution according to the size of the images T to be displayed from the VRAM 4 and selects textures having the resolution according to the size of the images T to be displayed.

In step S106, the controller 3 then deforms the selected textures to generate the images T of the pages. Specifically, the GUI base section 30 rotates the textures that form the plurality of images T and are arranged along the first imaginary axis of rotation Q around the second imaginary axis of rotation M, which intersects the first imaginary axis of rotation Q, and further rotates the textures around the first imaginary axis of rotation Q to generate the images T. The angle of rotation θ by which each page shown in FIG. 7A is rotated around the second imaginary axis of rotation M is determined by the image positioner 36.

The GUI base section 30 disposes a texture Ta in such a way that the texture Ta stands on the first imaginary axis of rotation Q set in an imaginary horizontal plane N in the imaginary space and rotates the texture Ta by the angle of rotation θ from a reference position R, where the lateral direction of the texture Ta is parallel to the lateral direction of the display area, around the second imaginary axis of rotation M that intersects the first imaginary axis of rotation Q, as shown in FIG. 7A. Further, the GUI base section 30 generates an image of the texture Ta having been rotated around the second imaginary axis of rotation M in the imaginary space and further rotated by an angle of depression ϕ that is not shown around the first imaginary axis of rotation Q. That is, the GUI base section 30 generates an image of the texture Ta having been rotated around the second imaginary axis of rotation M and obliquely viewed down at the angle of depression ϕ, which is not shown, from a viewpoint above the upper edge of the texture Ta in the imaginary space. In other words, the image is generated as an image of the texture Ta in the form of a bird's-eye image obliquely viewed at the angle of depression ϕ, which is not shown, from the viewpoint above the upper edge of the texture Ta in the imaginary space. Before the texture is not rotated, the lateral direction of the texture is parallel to the lateral direction of the display area, and the angle of rotation θ is 0°. The second imaginary axis of rotation M is not necessarily parallel to an edge of the texture that is the edges of the texture that extend in the second direction, which is the longitudinal direction, and may intersect the edges of the texture that extend in the lateral direction.

Specifically, the GUI base section 30 first deforms a texture Tb shown in FIG. 7B, in which each page is viewed from the front, in the longitudinal direction with the lateral width of the texture Tb unchanged and shifts the right edge of the texture Tb in FIG. 7B relative to the left edge thereof by S·sin θ·tan ϕ to generate a texture Tc, as shown in FIG. 7C. The GUI base section 30 then generates a texture Td, which is the texture Tc in FIG. 7C reduced in size in the lateral direction by a factor of cos θ, as shown in FIG. 7D. As a result, the width of the texture Td is S·cos θ. The GUI base section 30 finally generates a texture Te, which is the texture Td in FIG. 7D reduced in size in the longitudinal direction by a factor of cos ϕ, as shown in FIG. 7E. As a result, the longitudinal dimension of the texture Te is L·cos ϕ. The thus generated image T is an image of the page rotated by the angle of rotation θ around the second imaginary axis of rotation M and further rotated around the first imaginary axis of rotation Q. In other words, the generated image T is an image of the page rotated around the second imaginary axis of rotation M by the angle of rotation θ and obliquely viewed down at the angle of depression ϕ from a viewpoint above the upper edge of the page.

In step S107, the controller 3 then positions the plurality of images T generated by the GUI base section 30 in the X-coordinate positions calculated by the image positioner 36 to generate the image bundle G.

In step S108, the controller 3 then displays the image bundle G on the image display section 2 in such a way that the images T are positioned in ascending order of page number from right to left on the image display section 2 along the lateral direction of the image display section 2.

According to the viewer 10 as the display apparatus and the display method described above, the images T displayed on the image display section 2 are textures each having the resolution according to the size of the images T selected from the texture band and displayed on the image display section 2 and are therefore not blurred or jaggy images but can be high-visibility images.

Further, since the texture bands each have any of the lateral resolutions reduced to the predetermined resolution multiplied by 1, ½, ¼, ⅛, 1/16, and 1/32 and any of the longitudinal resolutions reduced to the predetermined resolution multiplied by 1, ½, ¼, ⅛, 1/16, and 1/32, a texture can be readily selected from those having resolutions according to a variety of sizes of the images T.

### Second Embodiment

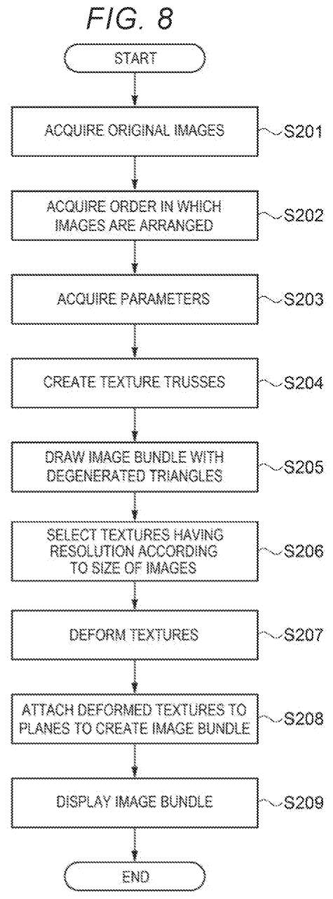

An overview of the action of a viewer according to a second embodiment will next be described with reference FIGS. 8 to 12.

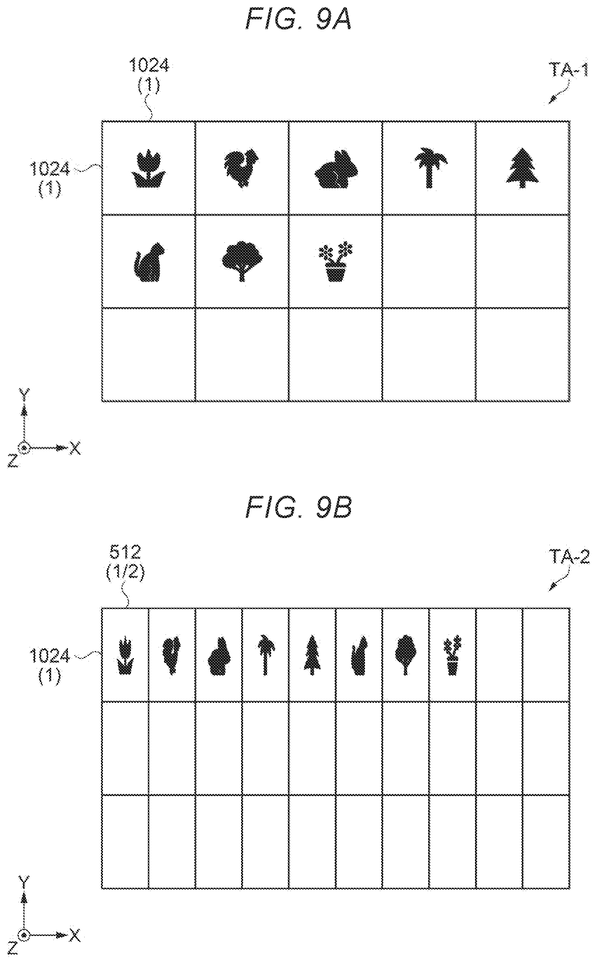

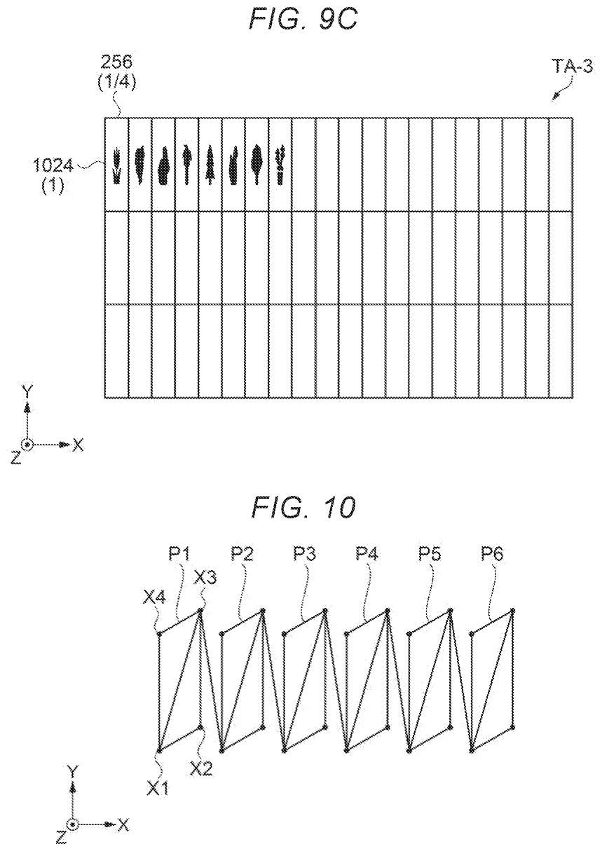

FIG. 8 is a flowchart showing an example of processes carried out by the viewer according to the second embodiment. FIGS. 9A to 9C each show a texture atlas. FIGS. 10 to 12 describe a method for drawing degenerated triangles to process an image.

Differences from the first embodiment described above will be primarily described, and the same items are not described. The present embodiment is the same as the first embodiment except that the RAM 5 stores a texture atlas creation program and a figure creation program that is based on an OpenGL (registered trademark) specification and that the image bundle G to be displayed on the image display section 2 is generated in a different method.

### Action of Viewer

The action of the viewer according to the present embodiment will be described along the flowchart shown in FIG. 8.

First of all, steps S201 to S203 are the same as steps S101 to S103 in the first embodiment and will therefore not be described.

In step S204, the controller 3 then causes the GUI base section 30 to create a plurality of texture atlases having different resolutions in the lateral direction from the original images of the pages. The texture atlases are each a set of textures having a longitudinal resolution corresponding to the original images of the pages and the same lateral resolution and arranged in the page order, as shown in FIGS. 9A, 9B, and 9C. FIG. 9A shows a texture atlas TA-1, in which the number of pages is eight and textures having a longitudinal resolution of 1024 bytes and a lateral resolution of 1024 bytes are arranged. FIG. 9B shows a texture atlas TA-2, in which textures having the longitudinal resolution of 1024 bytes and a lateral resolution of 512 bytes are arranged. FIG. 9C shows a texture atlas TA-3, in which textures having the longitudinal resolution of 1024 bytes and a lateral resolution of 256 bytes are arranged.

The controller 3 creates a texture atlas in which textures having a lateral resolution reduced by a factor of a power of two, that is, provided that the predetermined resolution is 1024 bytes, the controller 3 creates the texture atlas TA-1, in which textures corresponding to the original images of the pages and having the predetermined resolution multiplied by 1 are arranged, the texture atlas TA-2, in which textures corresponding to the original images of the pages and having the predetermined resolution multiplied by ½ are arranged, and the texture atlas TA-3, in which textures corresponding to the original images of the pages and having the predetermined resolution multiplied by ¼ are arranged, and stores the created texture atlases in the VRAM 4. Depending on the size of the images T to be displayed, the controller 3 may create a texture atlas having a lateral resolution reduced to the predetermined resolution multiplied by ⅛, 1/16 or 1/32.

The texture atlases TA-1, TA-2, and TA-3 can be created by executing the texture atlas creation program stored in the RAM 5.

In step S205, the controller 3 then causes the 3D image processor 38 to draw the contour of the image bundle G by using degenerated triangles, as shown in FIG. 10. The drawing is performed by executing the figure creation program based on the OpenGL (registered trademark) specification stored in the RAM 5 and used to draw a figure, such as a triangle, in a 3D space.

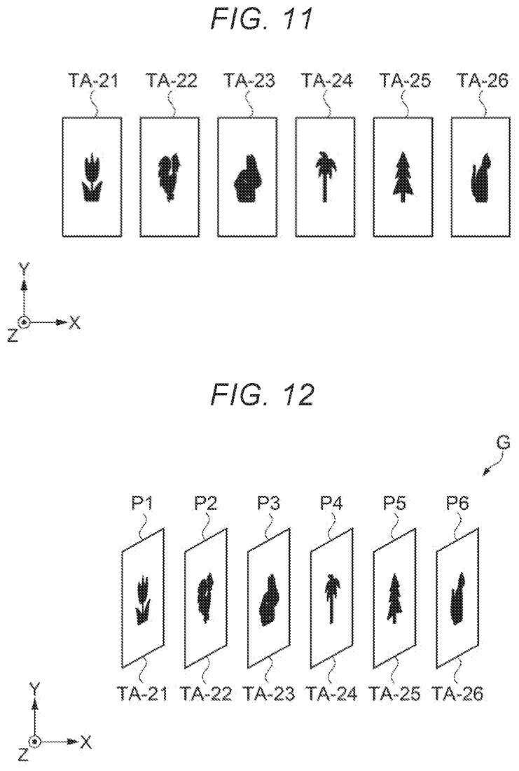

In step S206, the controller 3 then reads from the VRAM 4 a texture atlas containing textures each having the resolution according to the size of a plane P1 drawn with degenerated triangles having the size of the images T to be displayed and surrounded by vertices X1, X2, X3, and X4 and selects the texture having the resolution according to the size of the plane P1. When planes P1, P2, P3, P4, P5, and P6 each drawn with the degenerated triangles and surrounded by the four vertices have the same size, as shown in FIG. 10, the texture atlas TA-2 in FIG. 9B, for example, can be read, and six texture TA-21, TA-22, TA-23, TA-24, TA-25, and TA-26 can be collectively selected, as shown in FIG. 11.

Therefore, in the present embodiment, a plurality of textures having an optimum resolution can be selected only by reading a texture atlas once from the VRAM 4, whereas in the first embodiment, a texture band needs to be read from VRAM 4 for each of the images T, whereby the number of accesses to the VRAM 4 is reduced, and the images T and the image bundle G can be generated at higher speed.

The static section 52, in which a plurality of images T having the same size and inclination are arranged, as shown in FIG. 2, can therefore be produced at high speed. Further, as for the dynamic section 50, to select textures having the same resolution as that of the images T arranged in the static section 52, textures having an optimum resolution can be selected and the image bundle G can be generated only by reading a texture atlas once from the VRAM 4.

In step S207, the controller 3 then deforms the selected textures TA-21, TA-22, TA-23, TA-24, TA-25, and TA-26, as in step S106 in the first embodiment.

In step S208, the controller 3 then attaches the deformed textures TA-21, TA-22, TA-23, TA-24, TA-25, and TA-26 generated by the GUI base section 30 to the planes P1, P2, P3, P4, P5, and P6 drawn with the degenerated triangles to generate the image bundle G, as shown in FIG. 12.

In step S209, the controller 3 then displays the image bundle G generated by the GUI base section 30 on the image display section 2.

According to the viewer 10 as the display apparatus and the display method described above, the images T displayed on the image display section 2 are textures each selected from the texture atlases and having the resolution according to the size of the images T displayed on the image display section 2 and are therefore not blurred or jaggy images but can be high-visibility images. Further, a plurality of textures selected from the texture atlases are attached to a plurality of planes each drawn with degenerated triangles and surrounded by a plurality of vertices and then displayed on the image display section 2, whereby the images can be generated at higher speed.

Since the lateral resolution of a texture atlas is any of the resolutions reduced to the predetermined resolution multiplied by 1, ½, ¼, ⅛, 1/16, and 1/32, textures each having the resolution corresponding to the size of a plane drawn with degenerated triangles and surrounded by a plurality of vertices can be readily selected.

The contents derived from the embodiments described above will be described below.

The display method is a display method including rotating a plurality of images arranged along a first imaginary axis around a second imaginary axis that intersects the first imaginary axis, further rotating the plurality of images around the first imaginary axis, and displaying the plurality of images on a display section. The images are each a texture selected from a texture band and having a resolution according to the size of the image displayed on the display section, and the texture band is a ripmap in which the textures are arranged in a first direction along the first imaginary axis.

According to the display method, the images displayed on the display section are each a texture having the resolution according to the size of the image selected from the texture band and displayed on the display section and are therefore not blurred or jaggy images but can be high-visibility images.

In the display method described above, the texture band may have any of resolutions in the first direction reduced to a predetermined resolution multiplied by 1, ½, ¼, ⅛, 1/16, and 1/32 and any of resolutions in a second direction, which intersects the first direction, reduced to the predetermined resolution multiplied by 1, ½, ¼, ⅛, 1/16, and 1/32.

According to the display method, the texture band has any of resolutions in the first direction reduced to the predetermined resolution multiplied by 1, ½, ¼, ⅛, 1/16, and 1/32 and any of resolutions in the second direction, which intersects the first direction, reduced to the predetermined resolution multiplied by 1, ½, ¼, ⅛, 1/16, and 1/32, a texture can be readily selected from those having resolutions according to a variety of sizes of the images.

The display method is a display method including rotating a plurality of images arranged along a first imaginary axis around a second imaginary axis that intersects the first imaginary axis, further rotating the plurality of images around the first imaginary axis, and displaying the plurality of images on a display section. The images are each a texture selected from a plurality of texture atlases having different resolutions in the first direction along the first imaginary axis and having a resolution according to the size of the image displayed on the display section, and the textures are attached to planes drawn by degenerated triangles and surrounded by a plurality of vertices and then displayed on the display section.

According to the display method, the images displayed on the display section are each a texture selected from the texture atlases and having the resolution according to the size of the image displayed on the display section and are therefore not blurred or jaggy images but can be high-visibility images. Further, a plurality of textures selected from the texture atlases are attached to a plurality of planes each drawn with degenerated triangles and surrounded by a plurality of vertices and then displayed on the display section, whereby the images can be generated at higher speed.

In the display method described above, the texture atlases may each have any of resolutions in the first direction reduced to a predetermined resolution multiplied by 1, ½, ¼, ⅛, 1/16, and 1/32.

According to the display method, the texture atlases each have any of resolutions in the first direction reduced to the predetermined resolution multiplied by 1, ½, ¼, ⅛, 1/16, and 1/32, a texture having a resolution according to the size of a plane drawn with degenerated triangles and surrounded by a plurality of vertices can be readily selected.

A display apparatus includes a display section that displays an image bundle formed of a plurality of images, an image generator that rotates the plurality of images arranged along a first imaginary axis around a second imaginary axis that intersects the first imaginary axis and further rotates the plurality of images around the first imaginary axis to generate the plurality of images, and a controller that selects textures having resolutions according to the sizes of the images displayed on the display section from a texture band that is a ripmap in which the textures are arranged in a first direction along the first imaginary axis.

According to the display apparatus, the images displayed on the display section are each a texture having the resolution according to the size of the image selected from the texture band and displayed on the display section and are therefore not blurred or jaggy images but can be high-visibility images.

A display apparatus includes a display section that displays an image bundle formed of a plurality of images, an image generator that rotates the plurality of images arranged along a first imaginary axis around a second imaginary axis that intersects the first imaginary axis and further rotates the plurality of images around the first imaginary axis to generate the plurality of images, and a controller that selects textures having resolutions according to the sizes of the images displayed on the display section from a plurality of texture atlases having different resolutions in a first direction along the first imaginary axis, attaches the textures to planes each drawn with degenerated triangles and surrounded by a plurality of vertices, and then displays the textures on the display section.

According to the display apparatus, the images displayed on the display section are each a texture having the resolution according to the size of the image selected from the texture atlases and displayed on the display section and are therefore not blurred or jaggy images but can be high-visibility images. Further, a plurality of textures selected from the texture atlases are attached to a plurality of planes each drawn with degenerated triangles and surrounded by a plurality of vertices and then displayed on the image display section, whereby the images can be generated at higher speed.

What is claimed is:

1. A display method comprising:
rotating a plurality of images arranged along a first imaginary axis around a second imaginary axis that intersects the first imaginary axis;
further rotating the plurality of images around the first imaginary axis; and
displaying the plurality of images on a display section,
wherein the images are each a texture selected from a texture band and having a resolution according to a size of the image displayed on the display section, and
the texture band is a ripmap in which the textures are arranged in a first direction along the first imaginary axis.

2. The display method according to claim 1,
wherein the texture band has any of resolutions in the first direction reduced to a predetermined resolution multiplied by 1, ½, ¼, ⅛, 1/16, and 1/32, and
any of resolutions in a second direction that intersects the first direction reduced to the predetermined resolution multiplied by 1, ½, ¼, ⅛, 1/16, and 1/32.

3. A display method comprising:
rotating a plurality of images arranged along a first imaginary axis around a second imaginary axis that intersects the first imaginary axis;
further rotating the plurality of images around the first imaginary axis; and
displaying the plurality of images on a display section,
wherein the images are each a texture selected from a plurality of texture atlases having different resolutions in a first direction along the first imaginary axis and having a resolution according to a size of the image displayed on the display section, and
the textures are attached to planes each drawn by degenerated triangles and surrounded by a plurality of vertices and then displayed on the display section.

4. The display method according to claim 3,
wherein the texture atlases each have any of resolutions in the first direction reduced to a predetermined resolution multiplied by 1, ½, ¼, ⅛, 1/16, and 1/32.

5. A display apparatus comprises:
a display section that displays an image bundle formed of a plurality of images;
an image generator that rotates the plurality of images arranged along a first imaginary axis around a second imaginary axis that intersects the first imaginary axis and further rotates the plurality of images around the first imaginary axis to generate the plurality of images; and
a controller that selects textures having resolutions according to sizes of the images displayed on the display section from a texture band that is a ripmap in which the textures are arranged in a first direction along the first imaginary axis.

6. A display apparatus comprises:
a display section that displays an image bundle formed of a plurality of images;
an image generator that rotates the plurality of images arranged along a first imaginary axis around a second imaginary axis that intersects the first imaginary axis and further rotates the plurality of images around the first imaginary axis to generate the plurality of images; and
a controller that selects textures having resolutions according to sizes of the images displayed on the display section from a plurality of texture atlases having different resolutions in a first direction along the first imaginary axis, attaches the textures to planes each drawn with degenerated triangles and surrounded by a plurality of vertices, and then displays the textures on the display section.
